(19) United States
(12) Patent Application Publication
(10) Pub. No.: US 2008/0065478 A1
(43) Pub. Date: Mar. 13, 2008

(54) Electronic coupon based service for enhancing content

(75) Inventors: Bernhard Kohlmeier, Woodinville, WA (US); Francois Liger, Redmond, WA (US); Bjorn C. Rettig, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/519,480

(22) Filed: Sep. 12, 2006

(51) Int. Cl. G06Q 30/00

(52) U.S. Cl. 705/14

(57) ABSTRACT

Described herein is technology for, among other things, providing receiver side services for electronic content. The technology involves determining a price for a specific service to be executed on electronic content to be viewed by a receiver. A redeemable code associated with said pre-determined price is attached to the electronic content. This code, if the receiver chooses to redeem it, allows the receiver of a file to have a service provider perform a pre-priced service to the electronic document that the code relates to. The receiver has a choice to not redeem the code if they are satisfied with the electronic content and then no charge shall be incurred. The charge can be incurred if the receiver chooses to redeem the coupon in which case the service shall be provided to the electronic document.

### BACKGROUND

When communicating in a business setting it is important that all parties completely understand the intended meaning of a given document. This can be difficult to monitor when using a computerized system to translate from one language to another. For instance, there are thousands of different languages in use worldwide, and in today's competitive business market international expansion has become advantageous. With the use of high-speed Internet and email communication as well as web content, web applications, and the online distribution of client applications, international partners and clients are easily accessible, however the language barrier remains. It is essential that the receiver of an electronic document or application completely understands the senders intended meaning. However, when said receiver and sender do not share a language, another source is needed to provide the translation, which can be both difficult and expensive. In the past this problem has been addressed in two ways.

One attempt to address this problem is the use of software programs designed to automatically translate from one language to another using stored data from different languages. While in many circumstances the translation is accurate, the amount of vocabulary accessible to these programs is limited and the original meaning of the document can frequently be lost in the translation. Since the original drafter of the message does not posses any knowledge of the second language, the drafter has no way of knowing if it is an accurate translation of the intended message. In a business transaction, this presents a large problem. In the event that the receiver does not understand the message due to a poor translation, the receiver is now burdened with initiating augmentation and engaging with communication vendors, which will slow communication and can strain relations.

The second attempt to address this problem is the use of a language service provider. This consists of a third party that can translate electronic content into a given second language for a cost. While this method ensures accurate translation of the intended message this process can be slow and quickly becomes very costly. Human translation can be slow, tedious, and time consuming. The business is also now being charged additional fees each time a translated document is needed when, in many situations, a software program can conduct the translation efficiently without the added cost.

Although the difficulties concerning language barriers has been described above the problem is not specific to this feature of electronic content. Similar difficulties arise when using computerized communication methods regarding editing, legal services comprehension, power point presentations, speech to text transcription services, etc. If a receiver is not satisfied with the electronic content for any reason they are responsible for initiating the means in order to comprehend the content which is time consuming and can create tension in a business interaction.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Described herein is technology for, among other things, providing an electronic coupon based service for enhancing user content. A service, such as language translation, is to be performed on user content. An electronic coupon is generated and associated with the user content. This electronic coupon is sent to one or more users. If a user wishes to enhance the user content, the user can redeem the coupon and have the service enhance the user content. For example, a user can redeem the coupon which causes a human translator to better translate or improve upon the translation of a document. The sender of the electronic coupon is charged for the service.

### DESCRIPTION OF THE DRAWINGS

FIG. 1 is a block diagram showing a simplified example of a computerized system.

FIG. 2 is a block diagram showing a computer system according to an embodiment.

FIG. 3 is a flowchart of an exemplary computer implemented process for utilizing an electronic content service according to one embodiment.

FIG. 4 is a flowchart of an exemplary computer implemented process for utilizing an electronic content service according to another embodiment.

FIG. 5 is a flowchart of an exemplary computer implemented process for utilizing an electronic email service according to another embodiment.

FIG. 6 is a flowchart of an exemplary computer implemented process for utilizing an electronic email service according to another embodiment.

FIG. 7 is a flowchart of an exemplary computer implemented process for utilizing an electronic application service according to another embodiment.

FIG. 8 is a flowchart of an exemplary computer implemented process for utilizing an electronic Internet application service according to another embodiment.

FIG. 9 is a flowchart of an exemplary computer implemented process for utilizing an electronic content service according to another embodiment.

FIG. 10 is a flowchart of an exemplary computer implemented process for utilizing an electronic content service according to another embodiment.

### DETAILED DESCRIPTION

Reference will now be made in detail to various embodiments, examples of which are illustrated in the accompanying drawings. While the subject matter defined in the appended claims is described in conjunction with these embodiments, it is to be understood that the subject matter of the appended claims is not limited to these embodiments. On the contrary, these embodiments are intended to cover alternatives, modifications and equivalents that may be included within the spirit and scope of the subject matter of the appended claims. Furthermore, in the following description, numerous specific details are set forth in order to provide a thorough understanding, while in other instances, well-known methods, procedures, components, and modules have not been described in detail so as not to unnecessarily obscure aspects of these embodiments.

Some portions of the detailed descriptions that follow are presented in terms of procedures, logic blocks, processing, and other symbolic representations of operations within a computerized system. These descriptions and representations are the means used by those less skilled in the data processing arts to most effectively convey the substance of their work to others skilled in the art. In the present application, a procedure, logic block, process, or the like is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussion, terms such as “providing”, “processing”, “sending”, “receiving”, “storing”, “executing”, “performing”, “controlling”, “charging”, “updating”, “issuing” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

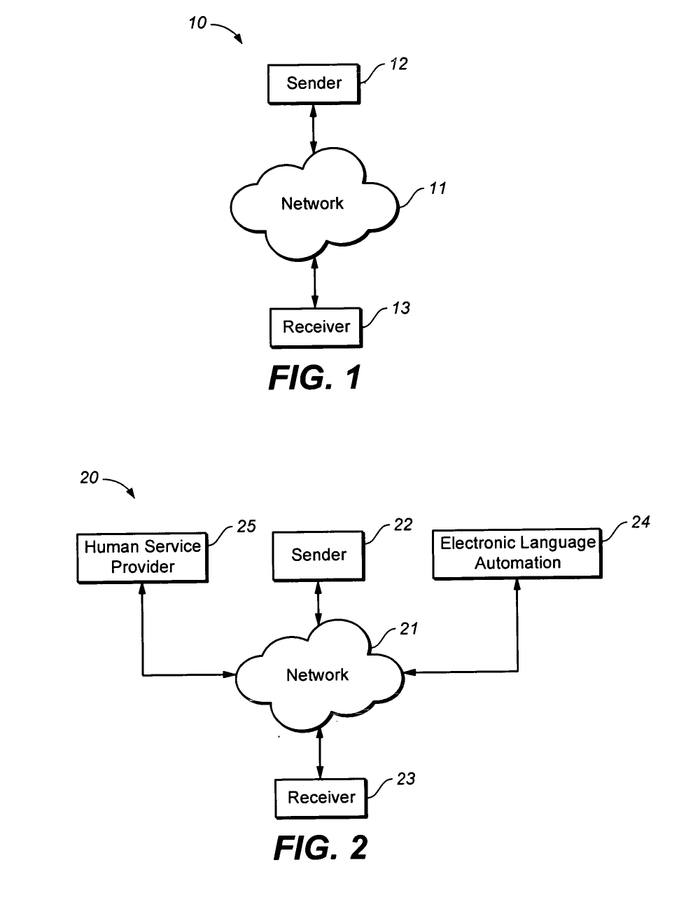

FIG. 1 is a block diagram of a simplified example of a computerized system 10. Computerized system 10 is only one example of a suitable computerized system and is not intended to suggest any limitation as to the scope or functionality. Neither should computerized system 10 be interpreted as having any dependency or requirement relating to any one or combination of components illustrated in the exemplary computerized system 10. For example although computer system 10 appears to have a single receiver, computer system 10 may actually have many receivers. In that respect, computer system 10 can be regarded as being representative of all the memory units that may be present in computerized system 10.

With reference to FIG. 1, components of computerized system 10 may include, but are not limited to a network 11, a sender 12 connected to network 11, and a receiver 13 also connected to network 11. Said network 11 may consist of but is not limited to a content server such as an Internet, or email connection. Sender 12 may use network 11 in order to send or distribute any form of electronic content including but not limited to emails, web applications, client applications, help files, documents, etc. Receiver 13 may use network 11 in order to receive any form of electronic content including but not limited to emails, web applications, client applications, help files, documents, etc. sent from said sender 12.

FIG. 2 is a block diagram of one embodiment of a suitable computerized system 20 containing additional service providers or communities. As mentioned above for network 11, network 21 may consist of but is not limited to a content server such as an Internet, or email connection. Also as mentioned for receiver 13, receiver 23 may use network 21 in order to receive any form of electronic content including but not limited to emails, web applications, client applications, help files, documents, etc. sent from sender 22. Although in this diagram there appears to be only one receiver, computerized system 20 may consist of many receivers and is therefore subject to the same assumptions as previously described computerized system 10.

In one embodiment, sender 22 may use an electronic language automation service 24 in order to translate any form of electronic content into a language other than that which it is written. The electronic content can include but is not limited to emails, documents, web applications, software applications, etc. Although this embodiment shows the electronic device 24 as a language automation device, it should be understood that device 24 may consist of any electronic software or other tool capable of performing an automated service such as, but not limited to, editing, legal explanation, voice to text translations etc. In this embodiment, electronic device 24 may be connected to sender 22, network 21, or both. In this way electronic device 24 is capable of transmitting the electronic content from sender 22 either back to said sender or to another location in network 21.

Furthermore, sender 22 in one embodiment is connected to a human service provider or community 25 which can be used to augment said electronic content from sender 202 in a way specific to said service provider. Although in this embodiment, human service provider 25 is responsible for providing a manual translation of an electronic document from one language to another, it should be understood that said service provider may perform any number of different services such as, but not limited to, editing, legal explanation, voice to text translations, etc. In this embodiment, human service provider 25 may be connected to sender 22, network 23, or both. In this way human service provider 25 is capable of transmitting the electronic content form sender 22 back to said sender or to another location in network 21.

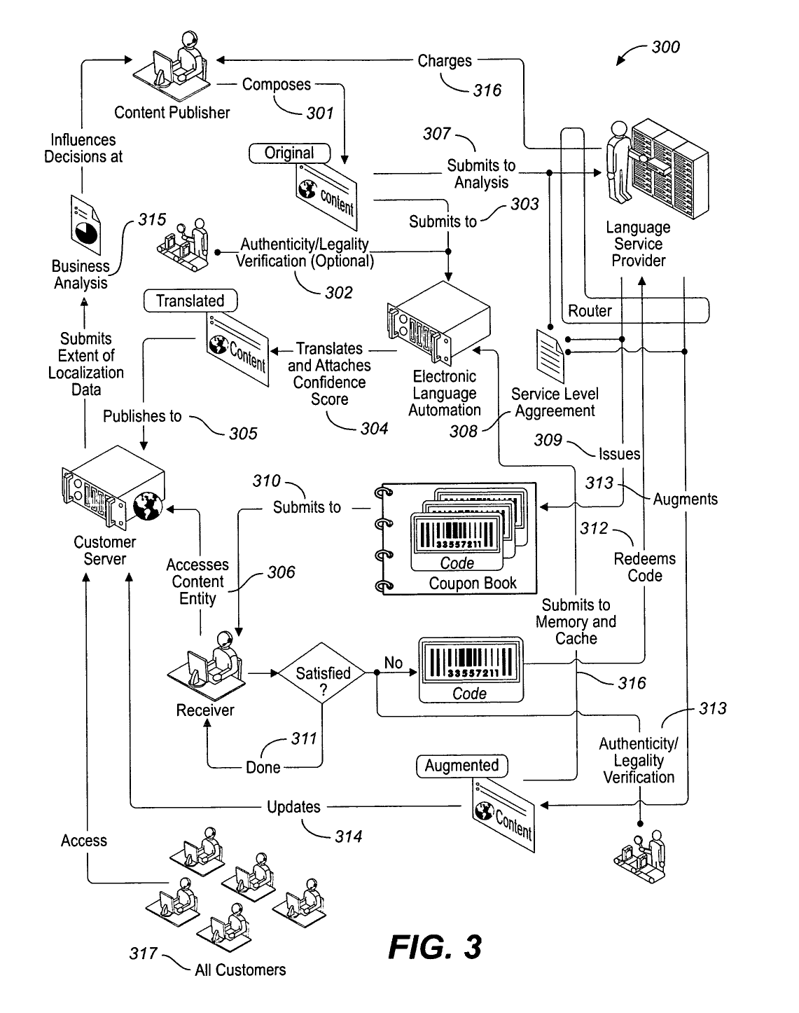

FIG. 3 is a flowchart of one exemplary computer implemented process 300 for utilizing an electronic content service according to one embodiment. Although specific step are disclosed in flowchart 300, such steps are exemplary. That is, embodiments are well suited to perform various other steps or variations of the steps recited in flowchart 300. It is appreciated that the steps in flowchart 300 may be performed in an order different than presented and that not all steps in flowchart 300 may be performed. All of, or a portion of, the methods described in flowchart 300 may be implemented using computer-readable and computer-executable instructions which reside, for example, in the computer-usable media of a computer system.

In one embodiment, flowchart 300 is executed in a suitable computerized system such as computerized system 20 (FIG. 2). In another embodiment, flowchart 300 is executed in computerized system 10 (FIG. 1), however it should be understood that these are exemplary systems and are not meant to limit the scope. It should be understood that there are other embodiments in which many variations upon computerized system 10 and 20 are acceptable.

In step 301 of FIG. 3, with reference to FIGS. 1 and 2, the content publisher composing the original content may be assumed to be sender 12 of FIG. 1 or sender 22 of FIG. 2. Similarly in step 303 with regard to FIG. 2, the content publisher of step 301 submits original content for analysis to electronic language automation, which in one embodiment can be electronic language automation 24 in FIG. 2. The content publisher of step 301 also submits the original content for analysis to a language service provider, which in one embodiment can be human service provider 25 in FIG. 2. The original content can be submitted to the language service provider and the electronic language automation either synchronously or asynchronously.

In one embodiment, authenticity/legality verification 302 is performed on the original content composed by content publisher 301. This verification can include but is not limited to computerized or manual tests to determine legality of the document or of the software used or authenticity of said document. In one embodiment, this authenticity/legality verification may include steps to verify that the Windows copy, or other software product, being used by the electronic content composer is an authentic copy rather than a pirated copy. As stated prior, although step 302 is shown in flowchart 300 it need not be performed and steps similar to it can be performed as well.

In step 304, in one embodiment the electronic language automation translates said original content from content publisher in step 301 into a second language and determines a “confidence score” based upon said translation. Said score is related to how confident the electronic translator is in the accuracy of its translation. This can be determined by, but is not limited to, the amount of words and grammatical structures that were or were not recognized by the translating electronic tool. This confidence score can be used by the content publisher to assess whether a language service provider is needed due to the accuracy of the translation. In one embodiment, the higher the score, the more confident the electronic language automation is in its translation. This score can be attached to the document so that if the document does go to the language service provider or receiver, the provider or receiver will be aware of the estimated accuracy of the translation.

In step 305 the translated content is published to a content server. With reference to FIGS. 1 and 2, the content server in step 305 in one embodiment can be assumed to be network 11 of FIG. 1 or network 21 of FIG. 2. In one embodiment as shown in step 305, after the translation and determination of the confidence score the now translated content is published to said content server.

In one embodiment, receiver in step 306 that can access the content server can be assumed to be receiver 13 in FIG. 1 or receiver 23 in FIG. 2. In step 306 the receiver accesses the content through the network, or content server. In one embodiment the receiver speaks the language that the original electronic content was translated into.

In step 307 described above, the content server sends the original content either simultaneously or asymultaneosly with step 303 to a language service provider. As shown in step 307, a router, can direct the content to the appropriate language service provider for the desired language translation. In one embodiment the language service provider, described above, consists of a human service provider, which in this case can provide a human translation of said document. In step 309 the language service provider issues a “coupon” or “coupon book” in which each coupon has a specific code that in turn is related to the original content or portion of the original content. Each code contains a value, which is the estimated cost of translating, based on a word count or other factors, of said original content or portion of original content. In one embodiment this estimated cost of the translation is agreed upon by the content publisher and the language service provider in step 308 where a “service level agreement” is reached. The service level agreement may contain other business agreements as well, such as the amount of time that should pass between the time that a receiver redeems a coupon, should it occur, and the time that the language service provider updates the content server with the augmented content.

In one embodiment the coupon, or coupon book as shown, possessing the list of codes pertaining to an agreed upon value are then submitted to the receiver shown in step 310. In this embodiment the codes are issued directly to the receiver though they can also pass through the network via email, Internet, or other form of electronic communication.

In step 306, as shown in this embodiment the receiver can access the translated content through the content server. The receiver can then determine whether they are satisfied with the document as shown in step 311, which in this embodiment suggests that the translation has been done accurately. If the receiver is satisfied the language service provider need not be used, and the process can be completed. However, if the receiver is not satisfied with the document or any portion of the document the receiver may then select the coupon with the code that corresponds to the portion or the content, which was not satisfactory shown in step 312. The coupon can consist of an icon embedded in the computerized document, an icon sent through a separate document, or in another sort of representation.

As shown in this embodiment, if the receiver is not satisfied they can redeem the coupon, shown in step 312. The language service provider can then receive a request to translate the content or potion of content that corresponds to the code of the coupon that the receiver selected. The language service provider then will then augment the selected document as shown in step 313. In this embodiment the augmentation is in the form of a human translation of the content composed by the publisher of step 301. The language service provider will then send the augmented content back to the content server to be viewed by the receiver or receivers as shown in 314 and charge the content publisher the agreed amount from step 308, the service level agreement, as shown in step 316. In this way, the content publisher is only charged the amount agreed upon in the service level agreement if the receiver redeems the coupon. Furthermore, the issuance of said coupons by the language service provider allows the receiver a provided for process to facilitate their comprehension of and satisfaction with a given piece of electronic content. The process should be opaque to the receiver who will only experience the augmentation through receiving the augmented content to provide the best possible user experience.

Continuing with FIG. 3, in this embodiment the content server is updated in step 314, which in this case means that the original translated content is now replaced with the augmented content from the language service provider. It should also be noted that although only one receiver has been mentioned throughout flowchart 300, there is an unlimited amount of receivers who can be able to access content from the content server represented by step 317. Each of these other receivers can be capable of the same coupon redemption process as previously described. However in this embodiment, once one coupon is redeemed for a part of the content or content as a whole, the augmented content from the language service provider can update the content server and the augmented content can be available to all receivers regardless if whether they were the receiver to redeem the coupon.

After the language service provider has augmented the content in step 313, in another embodiment shown in step 316 the electronic language automation can be updated with the new translation data, in order to improve the accuracy of the electronic translator in the future.

In regards to step 315, which involves a business analysis, this can include a data analysis, which can influence the content publishers decisions. On embodiment could be an extent of localization data analysis, which can be used to determine which documents in the future, should have a coupon option. In this way the content publisher is given feedback for the most successful use of aid coupons.

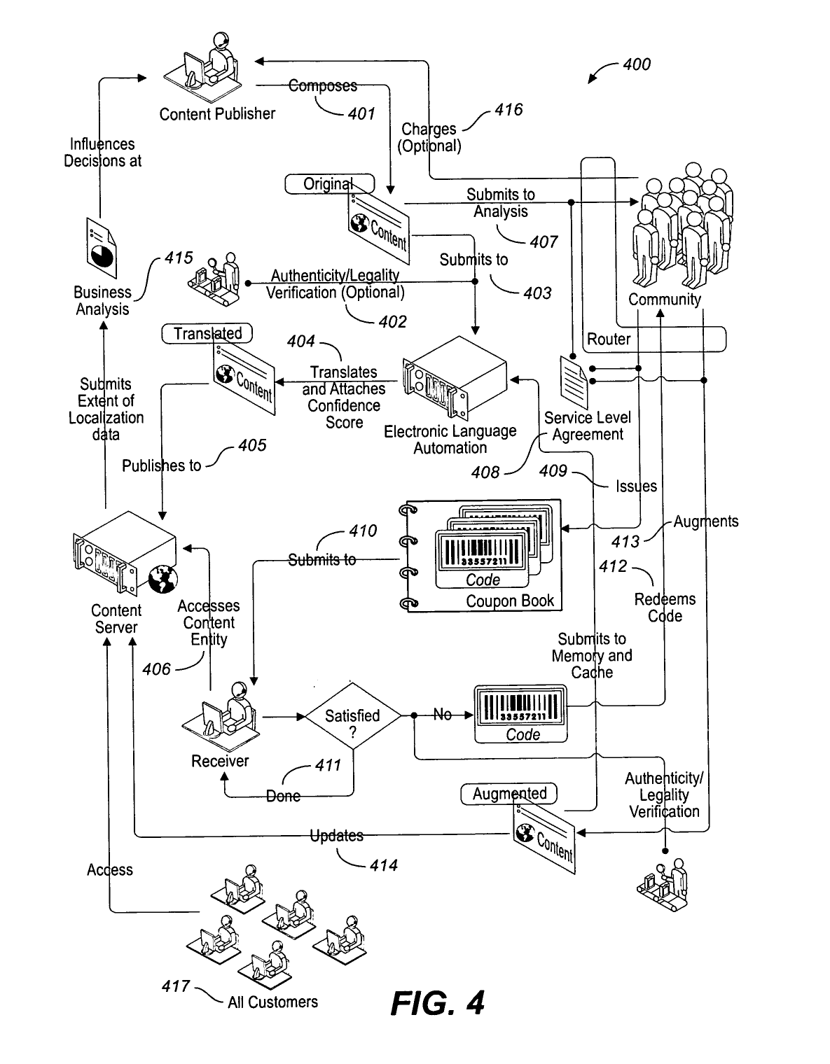

FIG. 4 is a flowchart of an exemplary computer implemented process 400 for utilizing an electronic content service similar to that which is described in FIG. 3. As previously stated in regards to FIG. 3, although specific step are disclosed in flowchart 400, or any other flowchart described herein, such steps are exemplary. Embodiments are well suited to perform various other steps or variations of the steps recited in flowchart 400. It is appreciated that the steps in flowchart 400 may be performed in an order different than presented and that not all steps in flowchart 400 may be performed. All of, or a portion of, the methods described in flowchart 400 may be implemented using computer-readable and computer-executable instructions which reside, for example, in a computer-usable media of a computer system.

The computer implement process 400 described in FIG. 4 contains the same steps as described in FIG. 3. The embodiment that is shown in this figure is the use of a community instead of a language service provider. In this embodiment the community can consists of any number of individuals who are proficient in both the language of the original content and the second language that the content is being translate too. In this embodiment the content publisher can submit the original content for analysis to the community as shown in step 407. The community shown in FIG. 4 can fill all of the same steps as the language service provider in FIG. 3.

Another embodiment, which can be more clearly illustrated by FIG. 4, is the optional charge characteristic. It should be understood that this feature is not particular or limited to this embodiment. Step 416 illustrates a charge being placed on the content publishers for the translation surfaces performed by the community. In one embodiment however the content publisher is not charged and this service is done for free for the content publisher. An example of where this feature could be relevant is the embodiment of the community being a government sanctioned group, or any other benefactor who could in a sense sponsor the community.

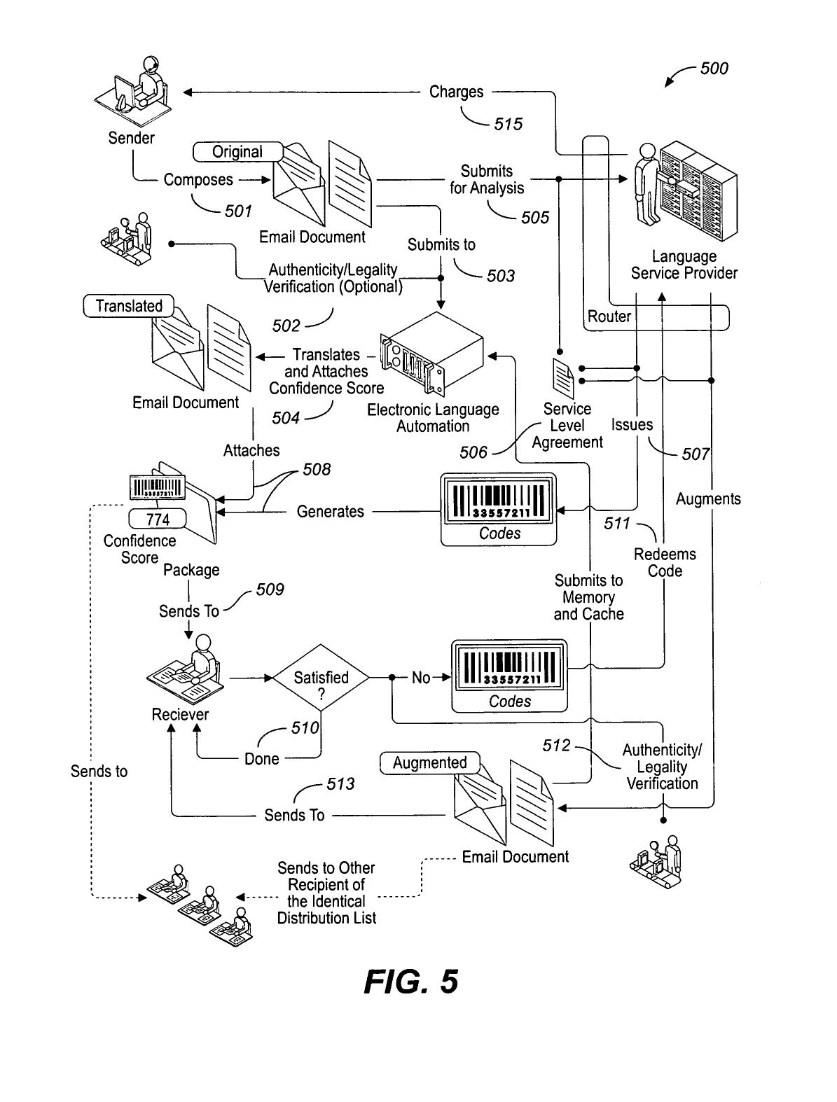

FIG. 5 is a flowchart of an exemplary computer implemented process 500 for utilizing an electronic email service according to another embodiment. The steps according to this embodiment are similar to those described in FIG. 3 and FIG. 4 however after the issuance of previously described code shown in step 507, the code is attached directly to the translated email document, shown in step 508, and then sent to a receiver shown in 509. The code attached to the email document step 508 can then be redeemed by the receiver by selecting the code icon in the email shown is step 511 if the receiver is not satisfied. After the code is attached directly to the email in step 508 the flowchart follows steps similar to that shown in FIGS. 3 and 4.

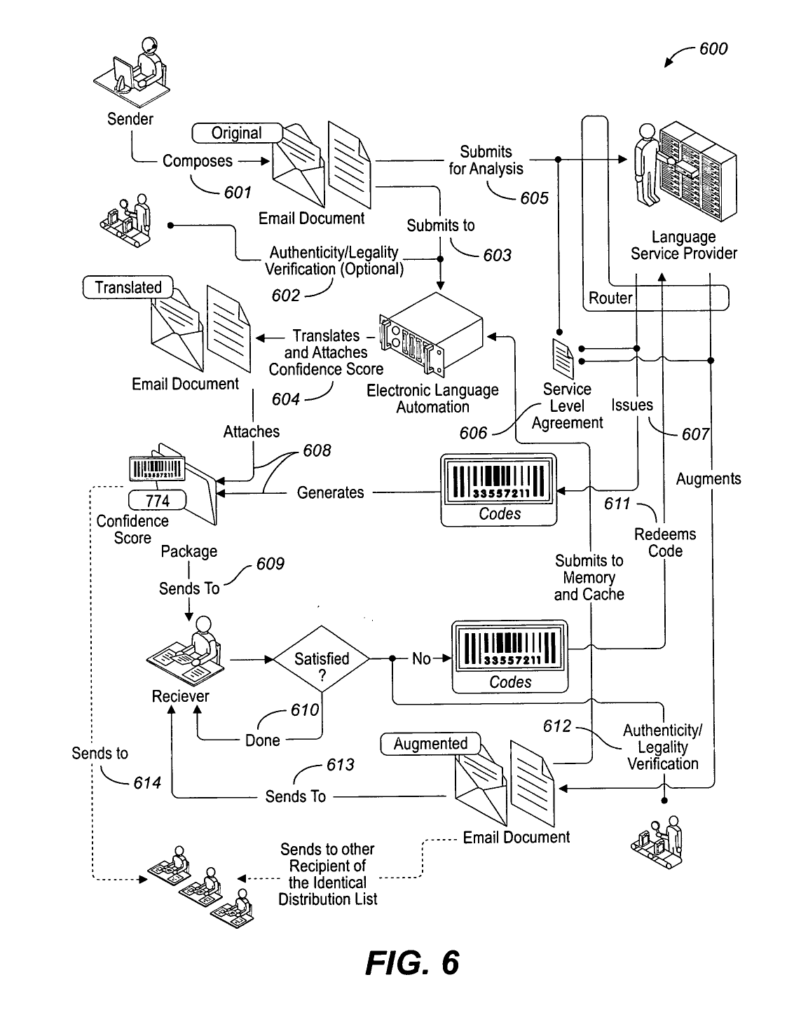

FIG. 6 is a flowchart of an exemplary computer implemented process 600 for utilizing an electronic email service according to another embodiment. The flowchart of computer-implemented process 600 is similar to that of computer implemented process 500 shown in FIG. 5. In relation to FIG. 5, exemplary computer system 500 describes an embodiment in which in step 515 the sender is charged the agreed upon amount in the service level agreement, said agreement shown in step 506. The sender is charged said amount after the receiver has redeemed a code from the language service provide for translation relating to a specific email or electronic document. In FIG. 6, exemplary computer system 600 describes an embodiment in which in step 615 the receiver is charge the agreed upon amount in the service level agreement, said agreement shown in step 606. The receiver is charged said amount after the receiver has redeemed a code from the language service provide for translation relating to a specific email or electronic document. It should be understood through these embodiments that the invention is not reliant upon which party is charged by the service provider and that in each embodiment is a charge is incurred it will be placed on the appropriate party

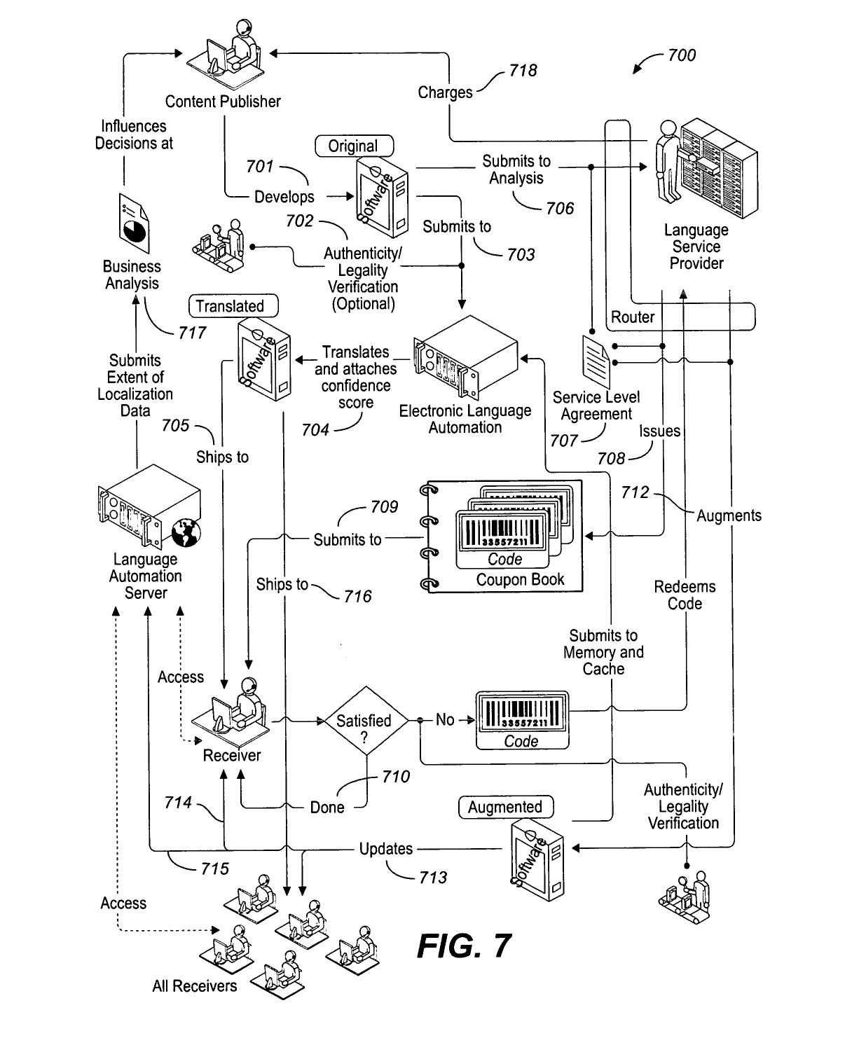

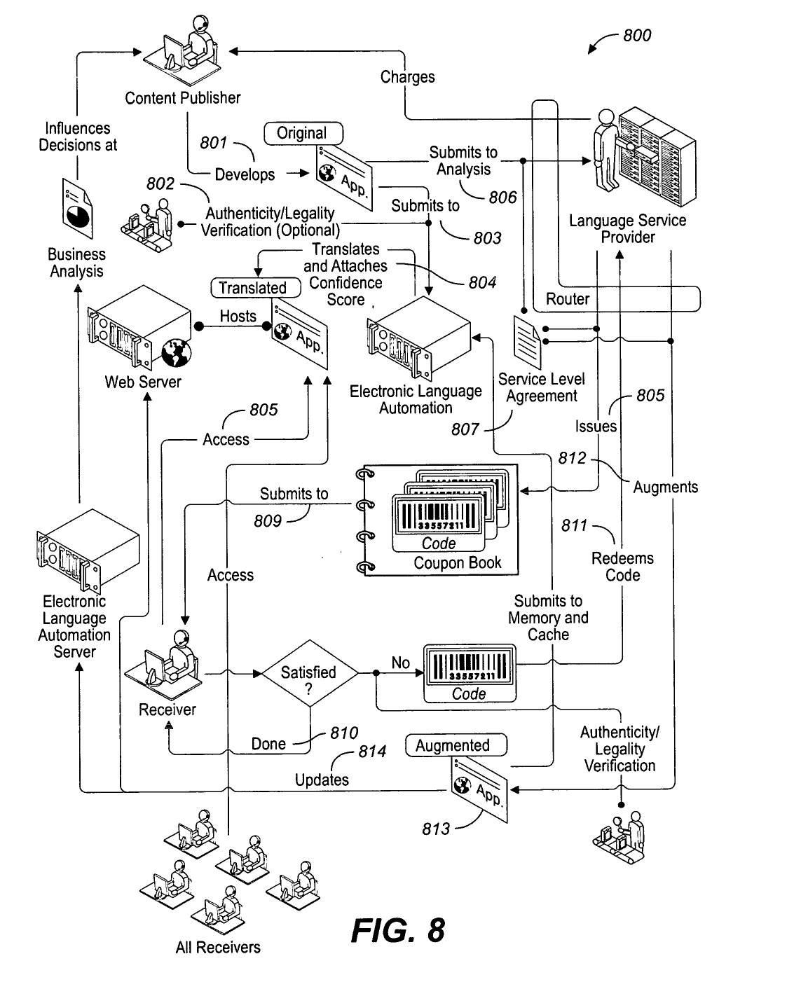

FIG. 7 is a flowchart of an exemplary computer implemented process 700 for utilizing an electronic application service according to another embodiment. The flowchart of computer-implemented process 700 is similar to that of computer implemented process 300 shown in FIG. 3. In relation to FIG. 1, exemplary computer system 300 describes an embodiment in which in step 301 the content publisher composes an original electronic content. In FIG. 7, exemplary computer implemented process 700 describes an embodiment in which in step 701, which relates to step 301 of FIG. 1, the content publisher develops a software application, which is then submitted to a electronic language automation in step 703 and a language service provider in step 706. A software application help file would be considered electronic content and would therefore apply to the embodiment described in FIG. 3.

In the embodiment shown in FIG. 7, in the event that the issued coupon is redeemed shown in step 711 and after the language service provider has augmented the translated software, the augmented software can then be sent back to the receiver, shown in step 713, and also back to the Language Automation Server shown in step 714. This embodiment provides a means for the software implemented on the server to be updated with the new augmented material.

FIG. 8 is a flowchart of an exemplary computer implemented process 800 for utilizing an electronic Internet application service according to another embodiment. The flowchart of computer-implemented process 800 is similar to that of computer implemented process 700 shown in FIG. 7. In relation to FIG. 7, exemplary computer system 700 describes an embodiment in which in step 701 the content publisher develops an original software program. In FIG. 8, the exemplary computer system 800 describes an embodiment where in step 801, which relates to step 701, the content publisher develops an original Internet application.

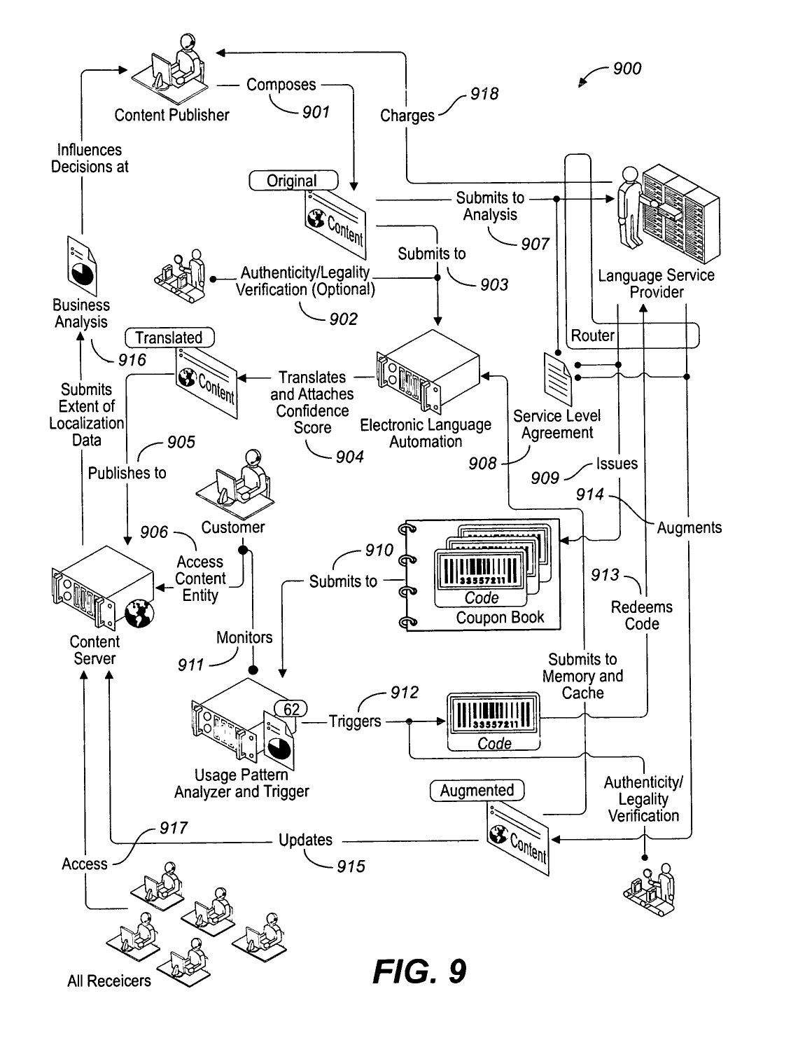

FIG. 9 is a flowchart of an exemplary computer implemented process 900 for utilizing an electronic content service according to another embodiment. The flowchart of computer-implemented process 800 is similar to that of computer implemented process 700 shown in FIG. 7. In this embodiment instead of the receiver controlling the redemption of the coupon there, is a usage pattern analyzer and trigger. In this embodiment the usage pattern analyzer and trigger is configured to monitor how many times the content published to the content server in step 905 is accessed by the receivers shown in step 906 and 917. In one embodiment, the usage pattern analyzer and trigger is configured to trigger a redemption of a coupon for a particular piece of electronic content after a pre-determined number of times said content is accessed or using similar methods such as distance calculations or content grouping. Usage pattern analyzer and trigger monitors the number of times the content is accessed in step 911 and after a pre-determined number of times triggers a code redemption shown in step 912. After the code redemption shown in step 912 the flowchart follows steps similar to that shown in FIG. 1.

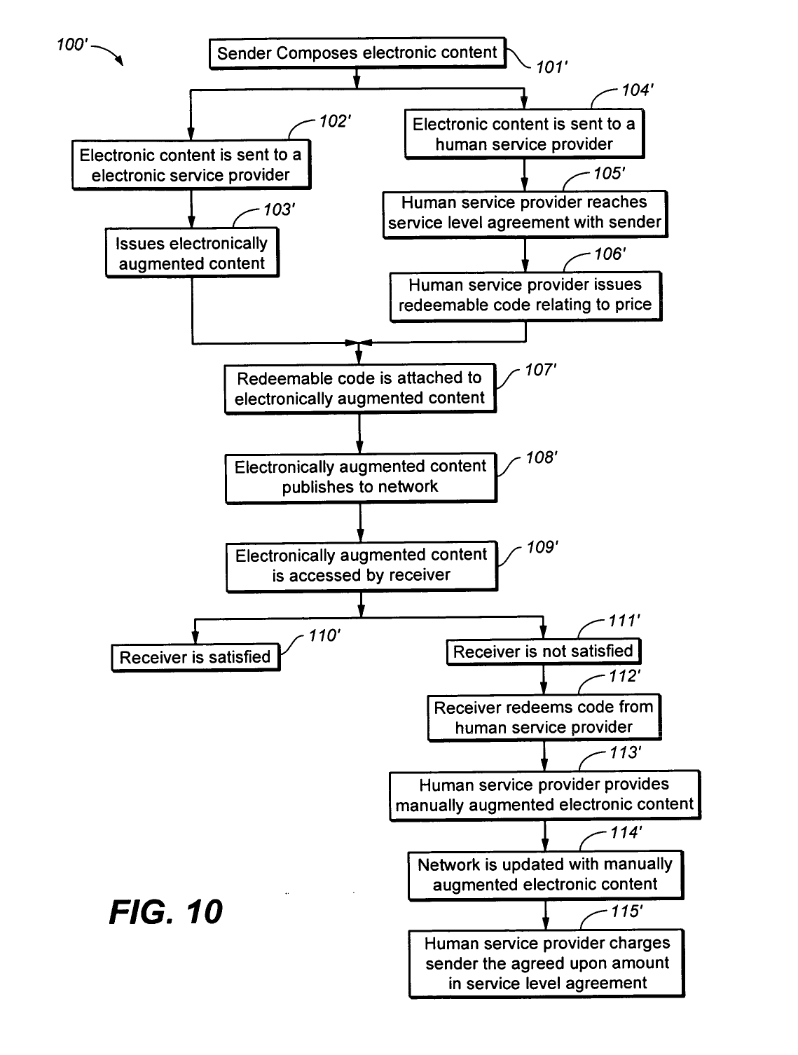

FIG. 10 is a flowchart of an exemplary computer implemented process for utilizing an electronic content service according to another embodiment. The flowchart of computer implemented process 100′ is similar to that of computer implemented process 300 shown in FIG. 3. In this embodiment there is no specification as to what particular service is provided by the electronic and human service provider. For example, the service could be an editing service, a legal translation service, a voice to text translation service, etc.

While the steps in flowchart 100′, are similar to the steps in flowchart 300, the service provided by the electronic service provider in step 304 is language automation whereas the specific service provided by the electronic service provider in step 103′ is not specified. The same can be said for the human service provider in step 313 which is know to be a human language translation, whereas the service provided by the human service provider in step 104′ is not specified. However, similar to flowchart 300 in step 106′ the human service provider issues a receiver redeemable code, which is then attached to the electronic content. This can be a prepaid code, which can include any of the embodiments previously described in FIGS. 3-9 such as charge to the sender, charge to the receiver, or services for free. Various different embodiments of the human service provider as well as the electronic content specified as shown in FIGS. 3-9 should also be understood to apply to FIG. 10 as well, such as the use of a community service provider, a web application, email, software application etc.

The previous description of the disclosed embodiments is provided to enable any person skilled in the art to make use of the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for providing an electronic coupon based service for enhancing user content, the method comprising:
determining a service to be executed on said user content;
associating an electronic coupon for performing said service to be executed on said user content in order to enhance said user content;
transmitting said electronic coupon to a particular user, wherein said user has access to said user content and if said user wishes to have said user content enhanced, the user can redeem said electronic coupon which causes said service to be performed on said electronic content and a sender of said electronic coupon is charged upon said user redeeming said electronic coupon.

2. The method as recited in claim 1, wherein said user content was previously translated from one language to a different language by a software program and said service comprises having a human translator improve upon a software translation.

3. The method as recited in claim 1 further comprising:
performing the service up to a pre-determined price corresponding to the electronic coupon.

4. The method as recited in claim 1 further comprising:
continuing to enhance the user content each time a coupon is redeemed.

5. The method as recited in claim 1 further comprising:
counting a number of times a specific user content has been accessed; and
automatically redeeming the electronic coupon after a pre-determined number has been reached.

6. The method as recited in claim 1 further comprising:
performing a business analysis in which information from a network is sent to the sender of said user content, said information comprising which codes have been redeemed, how many codes have been redeemed, and which electronic content has been accessed.

7. The method as recited in claim 1 further comprising:
reaching a service level agreement between a service level provider and said sender in which a price of said service and a time that will elapse between when said code is redeemed and when said service is finished.

8. The method as recited in claim 1 further comprising:
attaching a plurality of electronic coupons to said user content.

9. A system for selectively improving the quality of electronic content, the system comprising:
a server computer for providing said electronic content to a plurality of users through a network;
a client computer coupled to said network, wherein said client is capable of generating a coupon which enables a user receiving said coupon to optionally use the coupon to improve the quality of the electronic content.

10. The system as recited in claim 9, wherein a service provider provides improves the quality of said electronic content through human effort.

11. The system as recited in claim 9 wherein said service provider comprises a translation service.

12. The system as recited in claim 9 wherein the number of times said electronic content is accessed is counted and said code is automatically redeemed after a pre-determined number has been reached.

13. The system as recited in claim 9 wherein a business analysis is performed in which information from the network is sent to said electronic content sender, said information comprising; which codes have been redeemed, how many codes have been redeemed, and which electronic content has been accessed.

14. The system as recited in claim 9 wherein multiple redeemable codes are attached to said electronic content.

15. A computer-usable medium having computer readable program code stored thereon for causing a computer system to execute a method for providing pre-priced receiver side services for electronic content, the method comprising:
determining a price for a service to be executed on electronic content composed by a sender;
issuing and attaching a redeemable code associated with said price to said electronic content; and
initiating the service to be performed on said electronic content, charging said price to an appropriate party, and displaying augmented version of said electronic content to a receiver in the event that the code is redeemed.

16. The computer-usable medium as recited in claim 15 wherein a service provider provides said service to said electronic content, said service provider capable of determining and attaching an indicator of how well said service was executed

17. The computer-usable medium as recited in claim 15 wherein a security check is performed, said security check examining said electronic content for an item selected from the group consisting of: legality, content security, and authenticity.

18. The computer-usable medium as recited in claim 15 wherein the number of times said electronic content is accessed is counted and said attached code is automatically redeemed after a pre-determined number has been reached.

19. The computer-usable medium as recited in claim 15 wherein a business analysis is performed in which information from the network is sent to said electronic content sender, said information comprising; which codes have been redeemed, how many codes have been redeemed, and which electronic content has been accessed.

20. The computer-usable medium as recited in claim 15 wherein multiple redeemable codes are attached to said electronic content
